(19) United States
(12) Patent Application Publication
(10) Pub. No.: US 2026/0322427 A1
(43) Pub. Date: Oct. 15, 2026

(54) REDUCING BEAMFORMING OVERHEAD AND IMPROVING COVERAGE IN A WIRELESS COMMUNICATIONS SYSTEM (WCS)

(71) Applicant: Corning Research & Development Corporation, Corning, NY (US)

(72) Inventors: ANTHONY NG'OMA, Horseheads, NY (US); PO-TSUNG SHIH, Kennett Square, PA (US)

(73) Assignee: Corning Research & Development Corporation, Corning, NY (US)

(21) Appl. No.: 19/632,280

(22) Filed: Mar. 28, 2026

Related U.S. Application Data
(63) Continuation of application No. PCT/US2024/043147, filed on Aug. 21, 2024.
(60) Provisional application No. 63/541,006, filed on Sep. 28, 2023.

(51) Int. Cl. H04B 7/04

(52) U.S. Cl. CPC H04B 7/04013

(57) ABSTRACT

Reducing beamforming overhead and improving coverage in a wireless communications system (WCS) is disclosed. Herein, a radio node in a radio access network is configured to form a reduced number of radio frequency (RF) beams based on a smaller set of beamforming codewords to cover certain coverage areas in a coverage cell. Although using the smaller set of beamforming codewords can help reduce beamforming complexity and overhead, the reduced number of RF beams may leave a coverage hole(s) in the coverage cell to potentially degrade overall performance of the radio access network. In this regard, in embodiments disclosed herein, a passive and/or active reflector device(s) is provided at a strategically selected location(s) to receive and redirect any of the RF beams to thereby provide coverage in the coverage hole(s). As a result, it is possible to improve coverage concurrent to reducing beamforming overheads in the radio access network.

### BACKGROUND

This application claims the benefit of priority of U.S. Provisional Application No. 63/541,006, filed on Sep. 28, 2023, the content of which is relied upon and incorporated herein by reference in its entirety.

This disclosure relates generally to reducing beamforming overhead, such as reducing a number of codewords required for beamforming, in a wireless communications system (WCS), which can include a fifth generation (5G) system, a 5G new-radio (5G-NR) system, and/or a distributed communications system (DCS).

Wireless communication is rapidly growing, with ever-increasing demands for high-speed mobile data communication. As an example, local area wireless services (e.g., so-called “wireless fidelity” or “WiFi” systems) and wide area wireless services are being deployed in many different types of areas (e.g., coffee shops, airports, libraries, etc.). Communications systems have been provided to transmit and/or distribute communications signals to wireless devices called “clients,” “client devices,” or “wireless client devices,” which must reside within the wireless range or “cell coverage area” in order to communicate with an access point device. Example applications where communications systems can be used to provide or enhance coverage for wireless services include public safety, cellular telephony, wireless local access networks (LANs), location tracking, and medical telemetry inside buildings and over campuses. One approach to deploying a communications system involves the use of a radio node/base station that transmits communications signals distributed over physical communications medium remote unit forming radio frequency (RF) antenna coverage areas, also referred to as “antenna coverage areas.” The remote units each contain or are configured to couple to one or more antennas configured to support the desired frequency(ies) of the radio node to provide the antenna coverage areas. Antenna coverage areas can have a radius in the range from a few meters up to twenty meters, as an example. Another example of a communications system includes radio nodes, such as base stations, that form cell radio access networks, wherein the radio nodes are configured to transmit communications signals wirelessly directly to client devices without being distributed through intermediate remote units.

Operators of mobile systems, such as the Universal Mobile Telecommunications System (UMTS) and its offspring including Long Term Evolution (LTE) and LTE-Advanced, are increasingly relying on wireless small cell radio access networks (RANs) in order to deploy for example indoor voice and data services to enterprises and other customers. Such small cell RANs typically utilize multiple-access technologies capable of supporting communications with multiple users using RF signals and sharing available system resources such as bandwidth and transmit power. Evolved universal terrestrial radio access (E-UTRA) is the radio interface of 3GPP's LTE upgrade path for UMTS mobile networks. In these systems, there are different frequencies where LTE (or E-UTRA) can be used, and in such systems, user mobile communications devices connect to a serving system, which is represented by a cell. In LTE, each cell is produced by a node called eNodeB (eNB). A gNodeB (gNB) is a node in a cellular network that provides connectivity between user equipment (UE) and the evolved packet core (EPC).

For example, FIG. 1 is an example of a WCS 100 that includes a radio node 102 configured to support one or more service providers 104(1)-104(N) as signal sources (also known as “carriers” or “service operators”—e.g., mobile network operators (MNOs)) and wireless client devices 106(1)-106(W). For example, the radio node 102 may be a base station that includes modem functionality and is configured to distribute communications signal streams 108(1)-108(S) to the wireless client devices 106(1)-106(W) based on communications signals 110(1)-110(N) received from the service providers 104(1)-104(N). The communications signal streams 108(1)-108(S) of each respective service provider 104(1)-104(N) in their different spectrums are radiated through an antenna 112 to the wireless client devices 106(1)-106(W) in a communication range of the antenna 112. For example, the antenna 112 may be an antenna array. As another example, the radio node 102 in the WCS 100 in FIG. 1 can be a small cell radio access node (“small cell”) that is configured to support the multiple service providers 104(1)-104(N) by distributing the communications signal streams 108(1)-108(S) for the multiple service providers 104(1)-104(N) based on respective communications signals 110(1)-110(N) received from a respective evolved packet core (EPC) network CN₁-CN_{N} of the service providers 104(1)-104(N) through interface connections. The radio node 102 includes radio circuits 118(1)-118(N) for each service provider 104(1)-104(N) that are configured to create multiple simultaneous RF beams (“beams”) 120(1)-120(N) for the communications signal streams 108(1)-108(S) to serve multiple wireless client devices 106(1)-106(W). For example, the multiple RF beams 120(1)-120(N) may support multiple-input, multiple-output (MIMO) communications.

The WCS 100 may be configured to operate as a 5G and/or a 5G-NR communications system. In this regard, the radio node 102 can function as a 5G or 5G-NR base station (a.k.a. gNodeB) to service the wireless client devices 106(1)-106(W). Notably, the 5G or 5G-NR wireless communications system may be implemented based on a millimeter-wave (mmWave) spectrum that can make the communications signals 110(1)-110(N) more susceptible to propagation loss and/or interference. As such, it is desirable to radiate the RF beams 120(1)-120(N) via RF beamforming to help mitigate signal propagation loss and/or interference.

No admission is made that any reference cited herein constitutes prior art. Applicant expressly reserves the right to challenge the accuracy and pertinency of any cited documents.

### SUMMARY

Embodiments disclosed herein include reducing beamforming overhead and improving coverage in a wireless communications system (WCS). Herein, a radio node in a radio access network is configured to form a reduced number of radio frequency (RF) beams based on a smaller set of beamforming codewords to cover certain coverage areas in a coverage cell. Although using the smaller set of beamforming codewords can help reduce beamforming complexity and overhead, the reduced number of RF beams may leave a coverage hole(s) in the coverage cell to potentially degrade overall performance of the radio access network. In this regard, in embodiments disclosed herein, a passive and/or active reflector device(s) is provided at a strategically selected location(s) to receive and redirect any of the RF beams to thereby provide coverage in the coverage hole(s). As a result, it is possible to improve coverage concurrent to reducing beamforming overheads in the radio access network.

One exemplary embodiment of the disclosure relates to a radio access network. The radio access network includes a radio node. The radio node is configured to radiate a plurality of primary RF beams each steered toward a respective one of a plurality of primary beam directions to thereby cover a respective one of a plurality of primary coverage areas in a coverage cell. The radio access network also includes one or more reflector devices. Each of the one or more reflector devices is located at a respective mounting point in the coverage cell. Each of the one or more reflector devices is configured to receive at least one of the plurality of primary RF beams. Each of the one or more reflector devices is also configured to redirect the at least one of the plurality of primary RF beams to thereby cause at least one secondary RF beam steered toward at least one secondary beam direction to thereby cover at least one secondary coverage area in the coverage cell.

An additional exemplary embodiment of the disclosure relates to a method for reducing beamforming overhead in a WCS. The method includes radiating a plurality of primary RF beams each steered toward a respective one of a plurality of primary beam directions to thereby cover a respective one of a plurality of primary coverage areas in a coverage cell. The method also includes deploying one or more reflector devices to each receive at least one of the plurality of primary RF beams. The method also includes configuring each of the one or more reflector devices to redirect the at least one of the plurality of primary RF beams to cause at least one secondary RF beam steered toward at least one secondary beam direction to thereby cover at least one secondary coverage area in the coverage cell.

An additional exemplary embodiment of the disclosure relates to a WCS. The WCS includes a radio access network. The radio access network includes a radio node. The radio node is configured to radiate a plurality of primary RF beams each steered toward a respective one of a plurality of primary beam directions to thereby cover a respective one of a plurality of primary coverage areas in a coverage cell. The radio access network also includes one or more reflector devices. Each of the one or more reflector devices is located at a respective mounting point in the coverage cell. Each of the one or more reflector devices is configured to receive at least one of the plurality of primary RF beams. Each of the one or more reflector devices is also configured to redirect the at least one of the plurality of primary RF beams to thereby cause at least one secondary RF beam steered toward at least one secondary beam direction to thereby cover at least one secondary coverage area in the coverage cell.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary wireless communications system (WCS), such as a radio access network (RAN), configured to communicate communications signals with user devices via radio frequency (RF) beamforming;

FIGS. 2A-2B are schematic diagrams providing exemplary illustrations of some fundamental aspects related to RF beamforming;

FIG. 3 is a schematic diagram of an exemplary WCS configured according to any of the embodiments disclosed herein to reduce beamforming overhead concurrent to providing sufficient coverage in a radio access network;

FIG. 4 is a schematic diagram providing an exemplary top view of a radio access network configured according to an embodiment of the present disclosure to reduce beamforming overhead concurrent to providing sufficient coverage in the radio access network;

FIG. 5 is a flowchart of an exemplary process whereby the radio access network of FIG. 4 can reduce beamforming overhead concurrent to providing sufficient coverage;

FIG. 6 is a schematic diagram of an exemplary radio node that can be provided in the radio access network of FIG. 4 to radiate a set of RF beams in a coverage cell;

FIGS. 7A-7D are schematic diagrams providing exemplary illustrations of various configurations for improving coverage in the radio access network of FIG. 4;

FIG. 8 is a partial schematic cut-away diagram of an exemplary building infrastructure that includes the radio access network of FIG. 4 to reduce beamforming overhead concurrent to improving coverage;

FIG. 9 is a schematic diagram of an exemplary mobile telecommunications environment that can include the radio access network of FIG. 4 to reduce beamforming overhead concurrent to improving coverage; and

FIG. 10 is a schematic diagram of a representation of an exemplary computer system that can be included in or interfaced with any of the components in a WCS, including but not limited to the radio access network of FIG. 4, to reduce beamforming overhead concurrent to improving coverage.

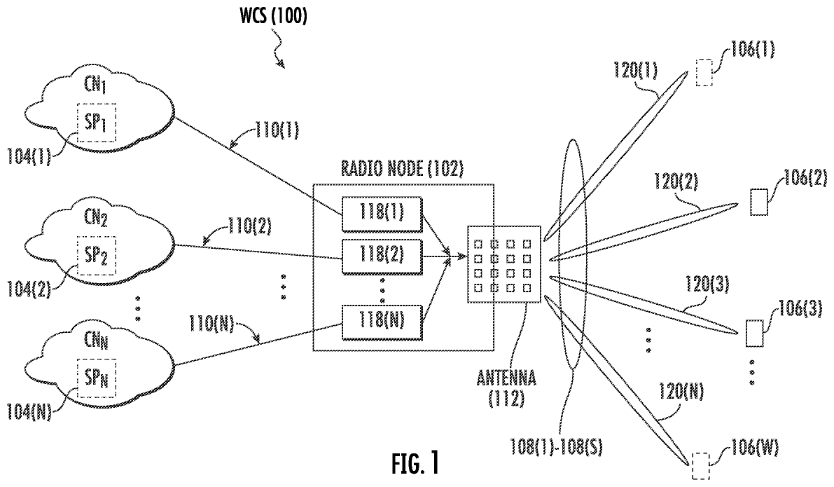

### DETAILED DESCRIPTION

Embodiments disclosed herein include reducing beamforming overhead and improving coverage in a wireless communications system (WCS). Herein, a radio node in a radio access network is configured to form a reduced number of radio frequency (RF) beams based on a smaller set of beamforming codewords to cover certain coverage areas in a coverage cell. Although using the smaller set of beamforming codewords can help reduce beamforming complexity and overhead, the reduced number of RF beams may leave a coverage hole(s) in the coverage cell to potentially degrade overall performance of the radio access network. In this regard, in embodiments disclosed herein, a passive and/or active reflector device(s) is provided at a strategically selected location(s) to receive and redirect any of the RF beams to thereby provide coverage in the coverage hole(s). As a result, it is possible to improve coverage concurrent to reducing beamforming overheads in the radio access network.

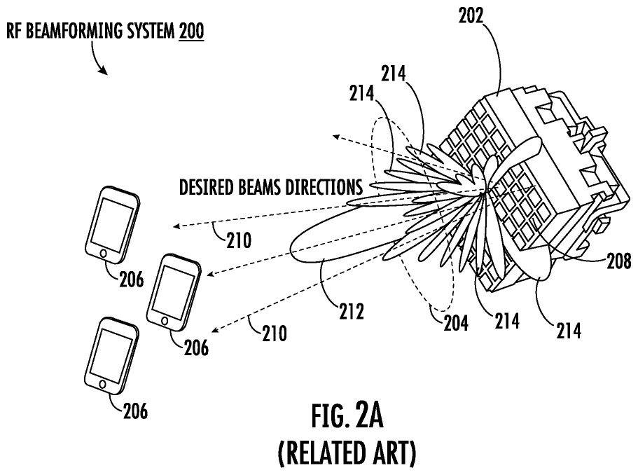

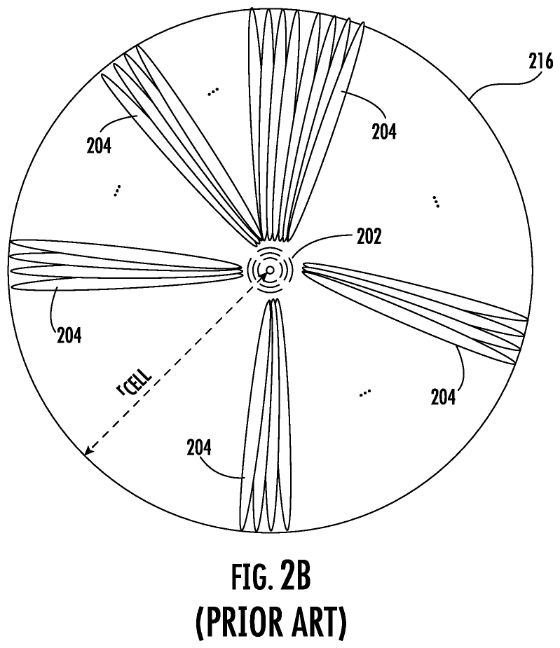

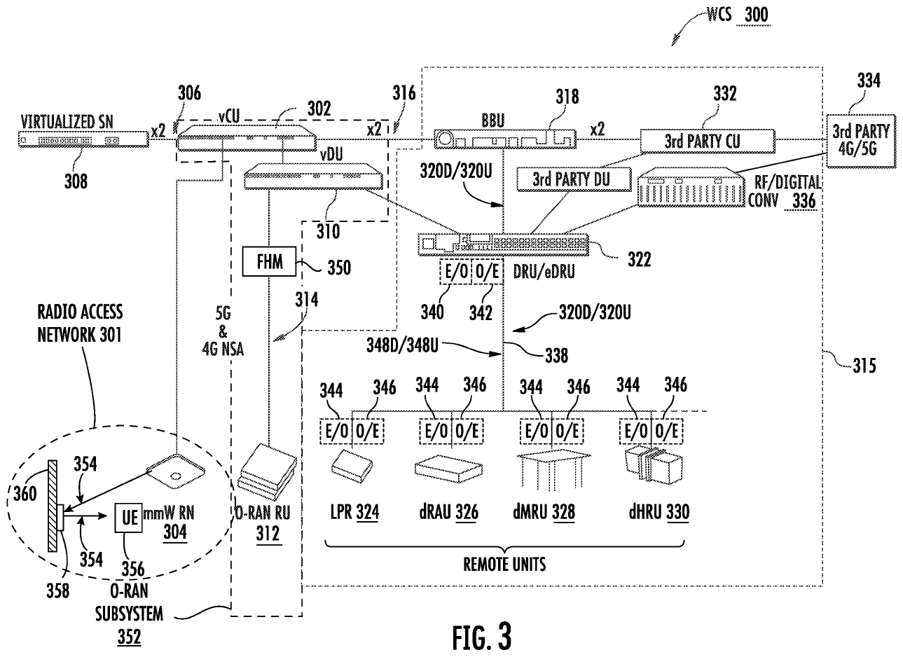

Before discussing a radio access network in a WCS that is configured to reduce beamforming overhead, starting at FIG. 3, a brief overview of a conventional beamforming system is first provided with reference to FIGS. 2A-2B to help explain some fundamental aspects related to RF beamforming.

FIG. 2A is a schematic diagram of an RF beamforming system 200 wherein an antenna array 202 emits an RF beam(s) 204 toward one or more user devices 206. The antenna array 202 includes multiple antenna elements 208 that are typically separated from each other by a distance (a.k.a. “antenna spacing”). The RF beam(s) 204 emitted from the antenna elements 208 includes multiple beamforming signals (not shown). The beamforming signals are preprocessed based on a set of complex-valued coefficients, which is commonly known as a beamforming codeword, and/or further processed to provide phase and/or amplitude changes as needed. Specifically, multiplication of the beamforming codeword is realized by a combination of digital processing and through phase and/or amplitude control applied at an input of the antenna elements 208 to thereby maximize an array gain in a desired beam direction(s) 210. By applying the set of complex-valued coefficients to the beamforming signals, the multiple simultaneously emitted beamforming signals can form the RF beam(s) 204, which may be multiple RF beams each described by gain, intensity, power, and/or electric/magnetic field values versus elevation and azimuth directions. In this regard, it can be said that the RF beam(s) 204 is associated with, or defined by, a respective beamforming codeword. Accordingly, a set of different beamforming codewords, often referred to as a beamforming codebook, can define multiple different RF beams in multiple beam directions.

Notably, the RF beam(s) 204 often includes a main lobe 212, where radiated power is concentrated and close to a maximum radiated power, and one or more sidelobes 214 with lesser amounts of radiated power. Typically, a radiation direction of the main lobe 212 determines the desired beam direction(s) 210 of the RF beam(s) 204, and a beamwidth of the RF beam(s) 204 is defined by a collection of radiation directions wherein the radiated power is not lower than 3 dB from the maximum radiated power. Understandably, the narrower the beamwidth, the more concentrated the radiated power will be in the main lob 212 and, thus, the farther distance the main lob 212 will be able to propagate. In contrast, the wider the beamwidth, the more spread the radiated power will be in the main lob 212 and, thus, the shorter distance the main lob 212 will be able to propagate. In this regard, the beamwidth of the RF beam(s) 204 is inversely related to propagation distance of the RF beam(s) 204.

The antenna array 202 can be provided in a radio node (e.g., eNB, gNB) to provide wireless communication services in a radio access network. FIG. 2B is a schematic diagram of an exemplary coverage cell 216 wherein the antenna array 202 in FIG. 2A can be configured to radiate multiple RF beams 204 to provide blanket coverage in the coverage cell 216. Common elements between FIGS. 2A and 2B are shown therein with common element numbers and will not be re-described herein.

As mentioned in FIG. 2A, the propagation distance of the RF beams 204 is inversely related to the beamwidth. In this regard, it may be desirable to form each of the RF beams with a narrower beamwidth to extend a radius r_{CELL} of the coverage cell 216. However, the antenna array 202 needs to increase the number of the RF beams 204 to provide blanket coverage in the coverage cell 216. Given each of the RF beams 204 is formed based on a respective beamforming codeword, the number of beamforming codewords must increase accordingly. Such an increased number of beamforming codewords can create several problems. First, the antenna array 202 needs to have sufficient storage (e.g., memory, register, etc.) to store an adequate processing resource to process the larger number of beamforming codewords, which can lead to an increased footprint and cost of the antenna array 202. Moreover, frequent switching between different RF beams 204 can also lead to an increase in computational and switching overhead. It is thus desirable to reduce the cost, complexity, and overhead associated with forming the RF beams 204, while concurrently maintaining sufficient coverage range in the coverage cell 216.

As described in detail below, a radio node (e.g., base station, access point, etc.) in a radio access network (e.g., small cell, picocell, femtocell, etc.) can be configured according to embodiments of the present disclosure to radiate a smaller set of narrow-beamwidth RF beams in a coverage cell to help extend coverage range and reduce beamforming overhead. Understandably, the smaller set of narrow-beamwidth RF beams may leave some coverage holes in the coverage cell that can potentially degrade user experiences in the radio access network. Thus, to help enhance coverage in the coverage cell, a set of reflector devices (passive and/or active) are provided at strategically selected locations to receive and redirect the RF beams toward the coverage holes. As a result, it is possible to improve coverage concurrent to reducing beamforming overheads in the radio access network.

FIG. 3 is a schematic diagram of an exemplary WCS 300 configured according to any of the embodiments disclosed herein to reduce beamforming overhead concurrent to providing sufficient coverage in a radio access network 301. The WCS 300 supports both legacy 4G LTE, 4G/5G non-standalone (NSA), and 5G standalone communications systems. As shown in FIG. 3, a centralized services node 302 (a.k.a. CU) is provided and is configured to interface with a core network to exchange communications data and distribute the communications data as radio signals to various wireless nodes. In this example, the centralized services node 302 is configured to support distributed communications services to a radio node 304 (e.g., 5G or 5G-NR gNB). Despite the fact that only one radio node 304 is shown in FIG. 3, it should be appreciated that the WCS 300 can be configured to include additional numbers of the radio node 304, as needed.

The functions of the centralized services node 302 can be virtualized through, for example, an x2 interface 306 to another services node 308. The centralized services node 302 can also include one or more internal radio nodes that are configured to be interfaced with a distribution unit (DU) 310 to distribute communications signals to one or more open radio access network (O-RAN) remote units (RUs) 312 that are configured to be communicatively coupled through an O-RAN interface 314. The O-RAN RUs 312 are each configured to communicate downlink and uplink communications signals in a respective coverage cell.

The centralized services node 302 can also be interfaced with a distributed communications system (DCS) 315 through an x2 interface 316. Specifically, the centralized services node 302 can be interfaced with a digital baseband unit (BBU) 318 that can provide a digital signal source to the centralized services node 302. The digital BBU 318 may be configured to provide a signal source to the centralized services node 302 to provide downlink communications signals 320D to a digital routing unit (DRU) 322 as part of a digital distributed antenna system (DAS). The DRU 322 is configured to split and distribute the downlink communications signals 320D to different types of remote units, including a low-power remote unit (LPR) 324, a radio antenna unit (dRAU) 326, a mid-power remote unit (dMRU) 328, and a high-power remote unit (dHRU) 330. The DRU 322 is also configured to combine uplink communications signals 320U received from the LPR 324, the dRAU 326, the dMRU 328, and the dHRU 330 and provide the combined uplink communications signals to the digital BBU 318. The digital BBU 318 is also configured to interface with a third-party central unit 332 and/or an analog source 334 through a radio frequency (RF)/digital converter 336.

The DRU 322 may be coupled to the LPR 324, the dRAU 326, the dMRU 328, and the dHRU 330 via an optical fiber-based communications medium 338. In this regard, the DRU 322 can include a respective electrical-to-optical (E/O) converter 340 and a respective optical-to-electrical (O/E) converter 342. Likewise, each of the LPR 324, the dRAU 326, the dMRU 328, and the dHRU 330 can include a respective E/O converter 344 and a respective O/E converter 346.

The E/O converter 340 at the DRU 322 is configured to convert the downlink communications signals 320D into downlink optical communications signals 348D for distribution to the LPR 324, the dRAU 326, the dMRU 328, and the dHRU 330 via the optical fiber-based communications medium 338. The O/E converter 346 at each of the LPR 324, the dRAU 326, the dMRU 328, and the dHRU 330 is configured to convert the downlink optical communications signals 348D back to the downlink communications signals 320D. The E/O converter 344 at each of the LPR 324, the dRAU 326, the dMRU 328, and the dHRU 330 is configured to convert the uplink communications signals 320U into uplink optical communications signals 348U. The O/E converter 342 at the DRU 322 is configured to convert the uplink optical communications signals 348U back to the uplink communications signals 320U.

In an embodiment, the DU 310 can be coupled to the O-RAN RUs 312 via a front-haul multiplexer (FHM) 350. In this regard, the CU 302, the DU 310, the FHM 350, and the O-RAN RUs 312 collectively form an O-RAN subsystem 352 in the WCS 300. Accordingly, the O-RAN subsystem 352 can be configured to operate based on the O-RAN shared-cell topology to support multiple RU clusters.

In an embodiment, the RN 304 may be configured to radiate a smaller set of narrow-beamwidth RF beams 354 in the radio access network 301. However, at least one user equipment (UE) 356 in the radio access network 301 may be in an area(s) not covered by any of the narrow-beamwidth RF beams 354. Thus, to communicate with the UE 356, at least one reflector device 358 may be provided in the radio access network 301 (e.g., mounted on a wall 360) to receive and redirect the narrow-beamwidth RF beams 354 toward the UE 356.

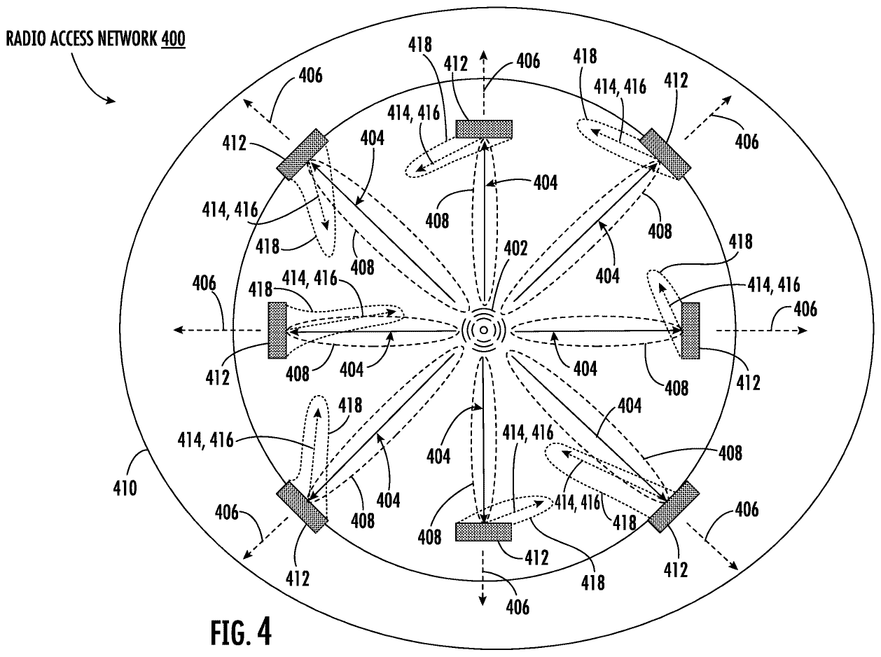

FIG. 4 is a schematic diagram providing an exemplary top view of a radio access network 400, which can be identical or functionally equivalent to the radio access network 301 in FIG. 3, configured according to an embodiment of the present disclosure to reduce beamforming overhead concurrent to providing sufficient coverage. Herein, the radio access network 400 includes a radio node 402, which can be a base station (e.g., eNB, gNB), a remote unit, or a wireless access point, as an example. The radio node 402 is configured to form a plurality of primary RF beams 404 and steer each of the primary RF beams 404 toward a respective one of a plurality of primary beam directions 406 to thereby cover a respective one of a plurality of primary coverage areas 408 in a coverage cell 410. The radio access network 400 also includes one or more reflector devices 412. Each of the reflector devices 412 are located at strategically selected locations in the coverage cell 410 to receive at least one of the primary RF beams 404. Herein, the strategically selected locations are so determined such that each of the reflector devices 412 can effectively redirect a respective one or more of the primary RF beams 404 to cause at least one secondary RF beam 414 steered toward at least one secondary beam direction 416 to thereby cover at least one secondary coverage area 418 in the coverage cell 410. Herein, the secondary coverage area 418 is nonoverlapping, at least partially, with the primary coverage areas 408 to thereby fill the coverage holes of the primary coverage areas 408. As a result, the radio node 402 may form a lesser number of the primary RF beams 404 with narrower beamwidths to help extend coverage range and reduce beamforming overhead. The strategically placed reflector devices 412, on the other hand, can steer the secondary RF beams 414 toward the secondary coverage areas 418 to thereby cover the coverage holes in the coverage cell 410. As a result, the radio access network 400 can effectively reduce beamforming overhead and improve coverage in the coverage cell 410 concurrently.

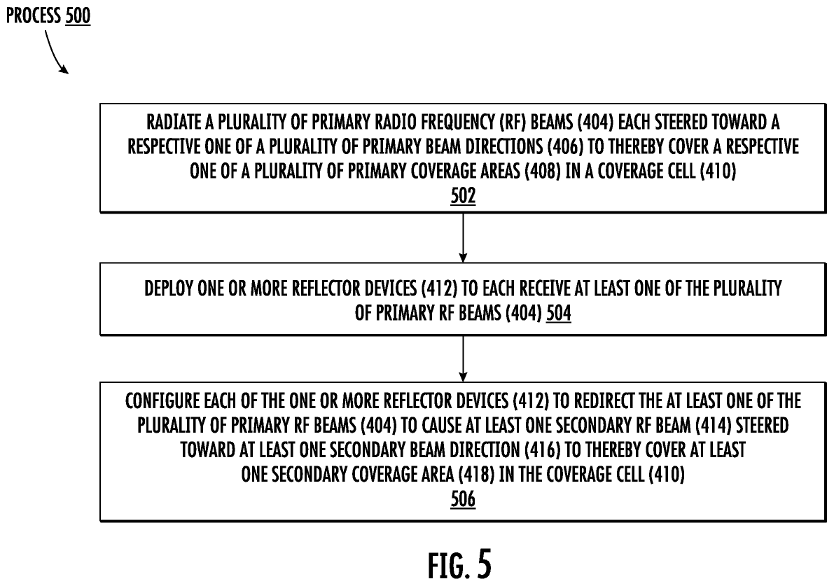

In an embodiment, the radio access network 400 can be configured to reduce beamforming overhead and improve coverage in the coverage cell 410 based on a process. In this regard, FIG. 5 is a flowchart of an exemplary process 500 for configuring the radio access network 400 of FIG. 4 to reduce beamforming overhead and improve coverage in the coverage cell 410.

Herein, the radio node 402 is configured to radiate the primary RF beams 404 and steer each of the primary RF beams 404 toward a respective one of the primary beam directions 406 to thereby cover a respective one of the primary coverage areas 408 in the coverage cell 410 (block 502). The reflector devices 412 can be deployed (e.g., at strategically selected locations in the radio access network 400) and each configured to receive at least one of the primary RF beams 404 (block 504). Each of the reflector devices 412 can be further configured to redirect the at least one received primary RF beams 404 to cause the secondary RF beam 414 and steer the secondary RF beam 414 toward the second beam direction 416 to thereby cover the secondary coverage area 418 in the coverage cell 410 (block 506).

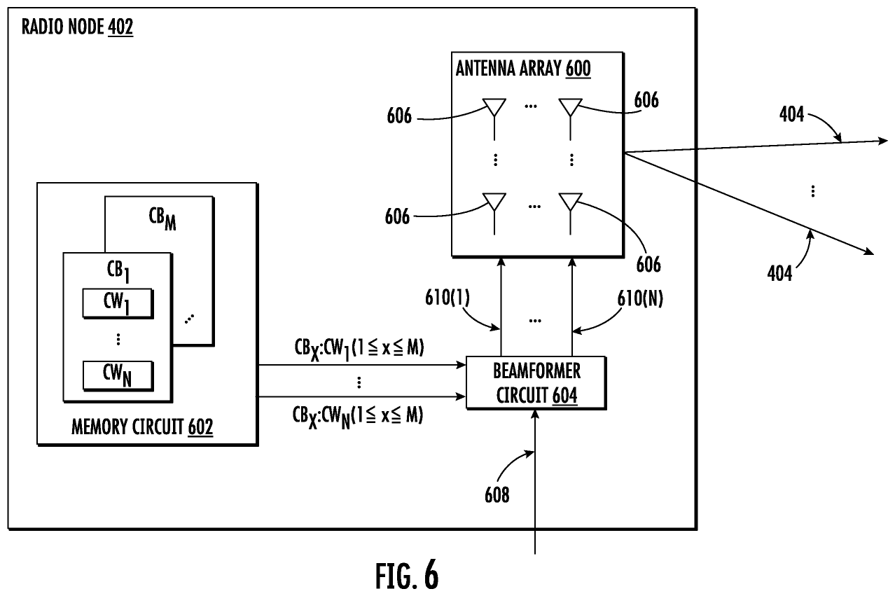

FIG. 6 is a schematic diagram of the radio node 402 in the radio access network 400 of FIG. 4 that is configured to radiate the primary RF beams 404 in the coverage cell 410. Common elements between FIGS. 4 and 6 are shown therein with common element numbers and will not be re-described herein.

In an embodiment, the radio node 402 includes an antenna array 600, a memory circuit 602, and a beamformer circuit 604. The antenna array 600 includes a plurality of antenna elements 606. The memory circuit 602, which may be solid-state disc (SSD), flash memory, as an example, is configured to store a plurality of beamforming codebooks CB₁-CB_{M}. Each of beamforming codebooks CB₁-CB_{M} includes a predetermined number of codewords CW₁-CW_{N} each determined to form a respective one of the primary RF beams 404.

The beamformer circuit 604 is configured to dynamically select a beamforming codebook CB_{X} among the beamforming codebooks CB₁-CB_{M}. The beamformer circuit 604 is also configured to process an RF signal 608 based on the codewords CW₁-CW_{N} in the selected beamforming codebook CB_{X} to generate a plurality of beamforming RF signals 610(1)-610(N). The beamformer circuit 604 then provides the beamforming RF signals 610(1)-610(N) to all the antenna elements 606 in the antenna array 600 to thereby form a respective one of the primary RF beams 404.

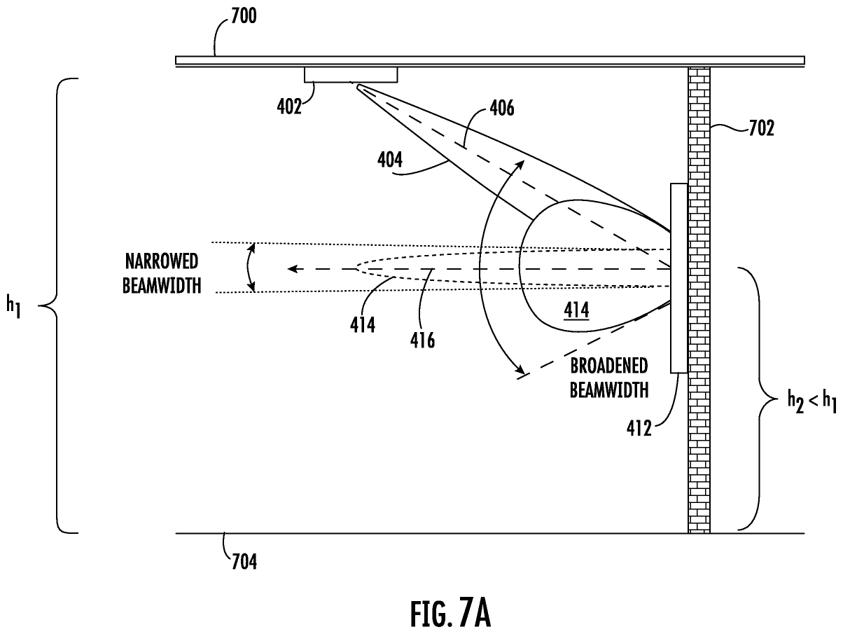

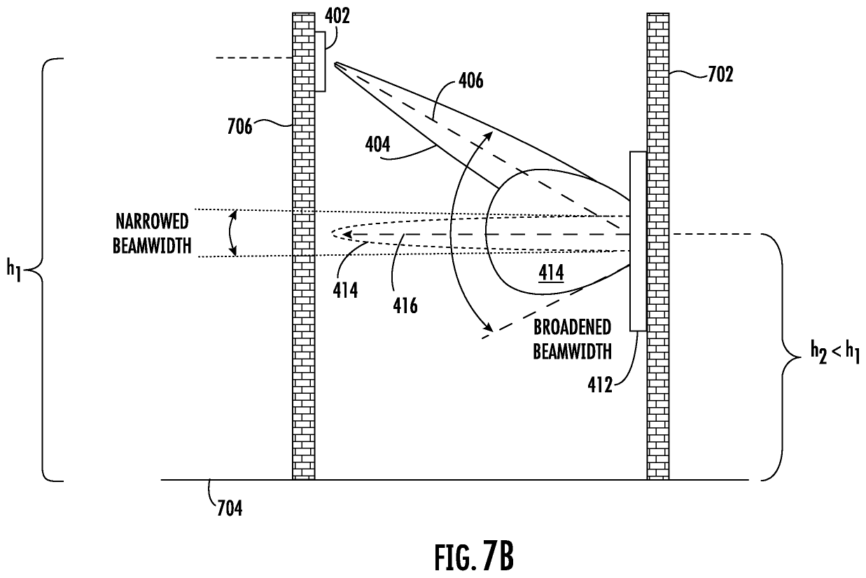

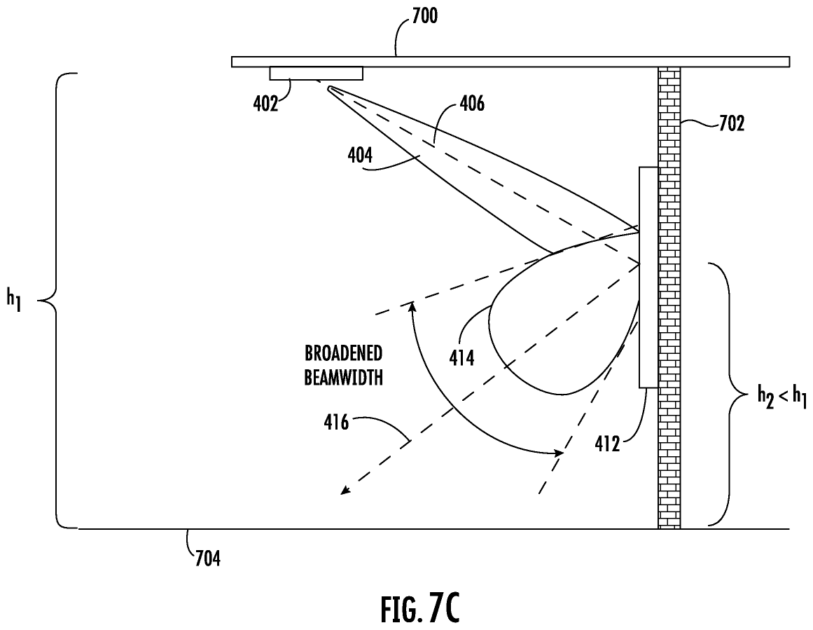

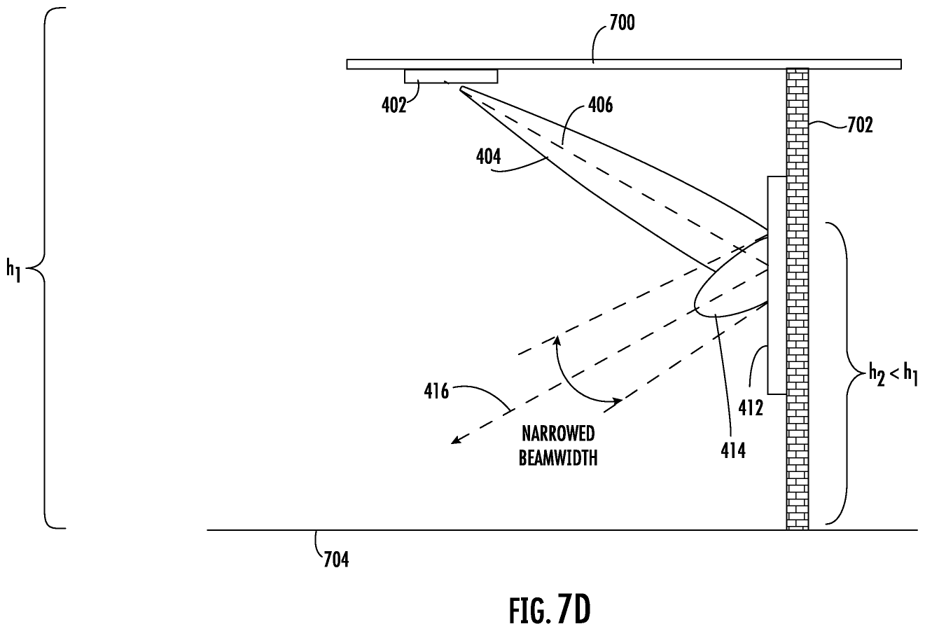

With reference back to FIG. 4, the reflector devices 412 can be provided at strategically selected mounting points to provide the best-possible coverage in the coverage cell 410. FIGS. 7A-7D are schematic diagrams providing exemplary illustrations of various reflector device configurations in the radio access network of FIG. 4. Common elements between FIGS. 4 and 7A-7D are shown therein with common element numbers and will not be re-described herein.

FIG. 7A illustrates a configuration wherein the radio node 402 is mounted on a ceiling 700 and the reflector device 412 is mounted on a wall 702. Specifically, the radio node 402 has a respective height h₁ relative to a ground 704 and the reflector device 412 has a respective height h₂ relative to the ground 704 (h₂<h₁). In this regard, the radio node 402 is mounted at a higher location than the reflector device 412. In an embodiment, the reflector device 412 may be mounted at a same height as an assumed UE (not shown).

In one embodiment, the reflector device 412 can be a diffraction reflector. Herein, a diffraction reflector is a passive device, which can be made of a metal plate with a diffraction structure on the surface, a convex metal plate, or a frequency selective surface (FSS) with meta-surface structure. The diffraction reflector will cause the secondary RF beam 414 to have a wider beamwidth than the primary RF beam 404 radiated by the radio node 402. Herein, the diffraction reflector is configured to steer the secondary RF beam 414 toward the secondary beam direction 416 that is horizontal to the ground 704.

In another embodiment, the reflector device 412 can be a reconfigurable intelligent surface (RIS). Herein, an RIS is an active device, which typically includes an array of unit cells that can be actively controlled to absorb the primary RF beam 404 and radiate the secondary RF beam 414. The RIS can be controlled to cause the secondary RF beam 414 to have a wider, a narrower, or an equal beamwidth compared to the primary RF beam 404 radiated by the radio node 402. Herein, the RIS is configured to radiate the secondary RF beam 414 with an equal or narrower beamwidth than the primary RF beam 404 and steer the secondary RF beam 414 toward the secondary beam direction 416 that is horizontal to the ground 704.

FIG. 7B illustrates a configuration wherein the radio node 402 is mounted on a second wall 706. Herein, the radio node 402 is also mounted at a higher location than the reflector device 412. The reflector device 412, which can be a passive diffraction reflector or an active RIS, is configured to steer the secondary RF beam 414 toward the secondary beam direction 416 that is horizontal to the ground 704.

FIG. 7C illustrates a similar configuration as in FIG. 7A. Herein, the reflector device 412 is a diffraction reflector and is configured to steer the secondary RF beam 414 toward the ground 704.

FIG. 7D illustrates a similar configuration as in FIG. 7C. Herein, the reflector device 412 is a specular reflector and is configured to steer the secondary RF beam 414 toward the ground 704. Notably, the secondary RF beam 414 redirected by the specular reflector typically has a narrower beamwidth than the primary RF beam 404. Moreover, a reflection angle of the secondary RF beam 414 is typically identical to an incident angle of the primary RF beam 404.

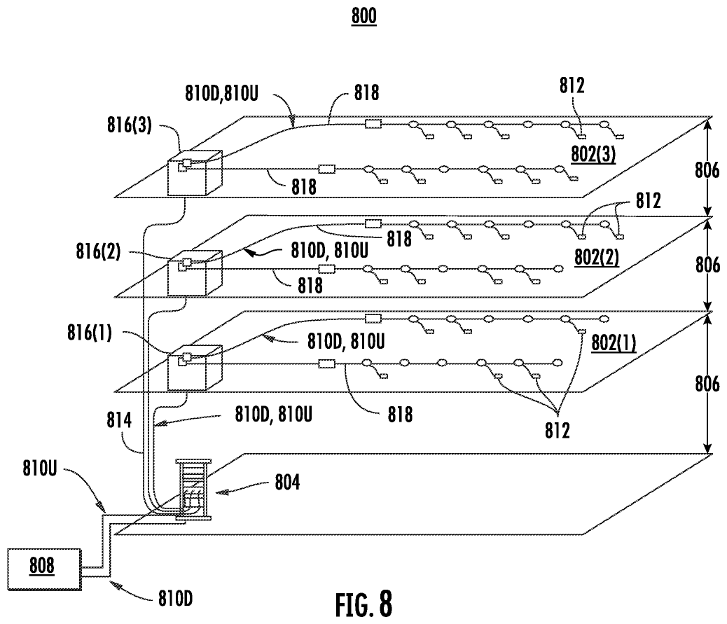

FIG. 8 is a partial schematic cut-away diagram of an exemplary building infrastructure 800 that includes an exemplary RAN system 802, including but not limited to the radio access network 400 of FIG. 4, wherein the RAN system 802 includes multiple RANs 804 implemented according to a RAN standard (e.g., O-RAN standard) and each configured to transparently interface with shared RUs through an intermediary neutral host agent device. The building infrastructure 800 in this embodiment includes a first (ground) floor 802(1), a second floor 802(2), and a third floor 802(3). The floors 802(1)-802(3) are serviced by one or more RANs 804 to provide antenna coverage areas 806 in the building infrastructure 800. The RANs 804 are communicatively coupled to a core network 808 to receive downlink communications signals 810D (downlink communications signals 810D can include downlink channels) from the core network 808. The RANs 804 are communicatively coupled to a respective plurality of RUs 812 to distribute the downlink communications signals 810D to the RUs 812 and to receive uplink communications signals 810U (uplink communications signals 810U can include uplink channels) from the RUs 812, as previously discussed above. Any RU 812 can be shared by any of the multiple RANs 804.

The downlink communications signals 810D and the uplink communications signals 810U communicated between the RANs 804 and the RUs 812 are carried over a riser cable 814. The riser cable 814 may be routed through interconnect units (ICUs) 816(1)-816(3) dedicated to each of the floors 802(1)-802(3) that route the downlink communications signals 810D and the uplink communications signals 810U to the RUs 812 and also provide power to the RUs 812 via array cables 818.

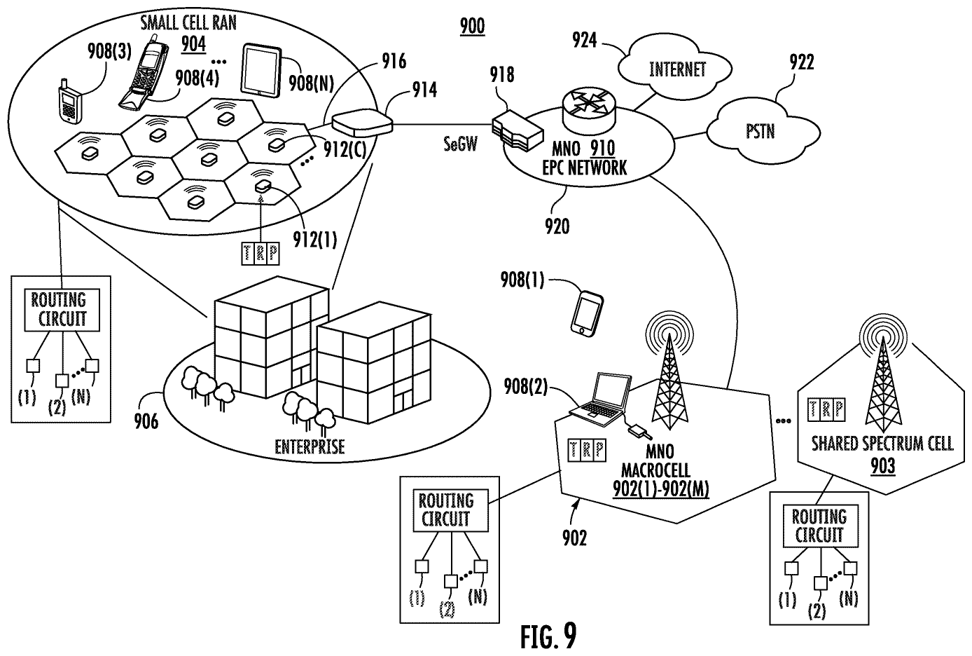

FIG. 9 is a schematic diagram of an exemplary mobile telecommunications RAN system 900 (also referred to as “RAN system 900”) that can include, but is not limited to, the radio access network 400 of FIG. 4, wherein the RAN system 900 includes multiple RANs implemented according to a RAN standard (e.g., O-RAN standard) and each configured to transparently interface with shared RUs through an intermediary neutral host agent device.

In this regard, RAN system 900 includes exemplary macrocell RANs 902(1)-902(M) (“macrocells 902(1)-902(M)”) and an exemplary small cell RAN 904 located within an enterprise environment 906 and configured to service mobile communications between a user mobile communications device 908(1)-908(N) to a mobile network operator (MNO) 910. A serving RAN for the user mobile communications devices 908(1)-908(N) is a RAN or cell in the RAN in which the user mobile communications devices 908(1)-908(N) have an established communications session with the exchange of mobile communications signals for mobile communications. Thus, a serving RAN may also be referred to herein as a serving cell. For example, the user mobile communications devices 908(3)-908(N) in FIG. 9 are being serviced by the small cell RAN 904, whereas the user mobile communications devices 908(1) and 908(2) are being serviced by the macrocell 902. The macrocell 902 is an MNO macrocell in this example. The macrocell 902 can be or include a wireless device(s) that can be configured to selectively control whether received transmit channels are transmitted through an antenna array of the wireless device. However, a shared spectrum RAN 903 (also referred to as “shared spectrum cell 903”) includes a macrocell in this example and supports communications on frequencies that are not solely licensed to a particular MNO, such as CBRS for example, and thus may service user mobile communications devices 908(1)-908(N) independent of a particular MNO. The macrocell 902 can be or include a wireless device(s) that can be configured to selectively control whether received transmit channels are transmitted through an antenna array of the wireless device. The macrocell 902 can be a wireless device that can be configured to selectively control whether received transmit channels are transmitted through an antenna array of the wireless device. For example, the shared spectrum cell 903 may be operated by a third party that is not an MNO and wherein the shared spectrum cell 903 supports CBRS. The MNO macrocell 902, the shared spectrum cell 903, and the small cell RAN 904 may be neighboring radio access systems to each other, meaning that some or all can be in proximity to each other such that a user mobile communications device 908(3)-908(N) may be able to be in communications range of two or more of the MNO microcell(s) 902, the shared spectrum cell 903, and the small cell RAN 904 depending on the location of the user mobile communications devices 908(3)-908(N).

In FIG. 9, the RAN system 900 in this example is arranged as an LTE system as described by the Third Generation Partnership Project (3GPP) as an evolution of the GSM/UMTS standards (Global System for Mobile Communication/Universal Mobile Telecommunications System). It is emphasized, however, that the aspects described herein may also be applicable to other network types and protocols. The RAN system 900 includes the enterprise environment 906 in which the small cell RAN 904 is implemented. The small cell RAN 904 includes a plurality of small cell radio nodes 912(1)-912(C), which are wireless devices that can be configured to selectively control whether received transmit channels are transmitted through an antenna array of the wireless devices. Each small cell radio node 912(1)-912(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 9, the small cell RAN 904 includes one or more services nodes (represented as a single services node 914) that manage and control the small cell radio nodes 912(1)-912(C). In alternative implementations, the management and control functionality may be incorporated into a radio node, distributed among nodes, or implemented remotely (i.e., using infrastructure external to the small cell RAN 904). The small cell radio nodes 912(1)-912(C) are coupled to the services node 914 over a direct or local area network (LAN) connection 916 as an example, typically using secure IPsec tunnels. The small cell radio nodes 912(1)-912(C) can include multi-operator radio nodes. The services node 914 aggregates voice and data traffic from the small cell radio nodes 912(1)-912(C) and provides connectivity over an IPsec tunnel to a security gateway (SeGW) 918 in a network 920 (e.g., evolved packet core (EPC) network in a 4G network, or 5G Core in a 5G network) of the MNO 910. The network 920 is typically configured to communicate with a public switched telephone network (PSTN) 922 to carry circuit-switched traffic, as well as for communicating with an external packet-switched network such as the Internet 924.

The RAN system 900 also generally includes a node (e.g., eNodeB or gNodeB) base station, or “macrocell” 902. The radio coverage area of the macrocell 902 is typically much larger than that of a small cell where the extent of coverage often depends on the base station configuration and surrounding geography. Thus, a given user mobile communications device 908(3)-908(N) may achieve connectivity to the network 920 (e.g., EPC network in a 4G network, or 5G Core in a 5G network) through either a macrocell 902 or small cell radio node 912(1)-912(C) in the small cell RAN 904 in the RAN system 900. The neutral host agent device 915 could be provided between the macrocell 902 and the small cell RAN 904 to transparently manage communications between the macrocell 902 and the small cell RAN 904.

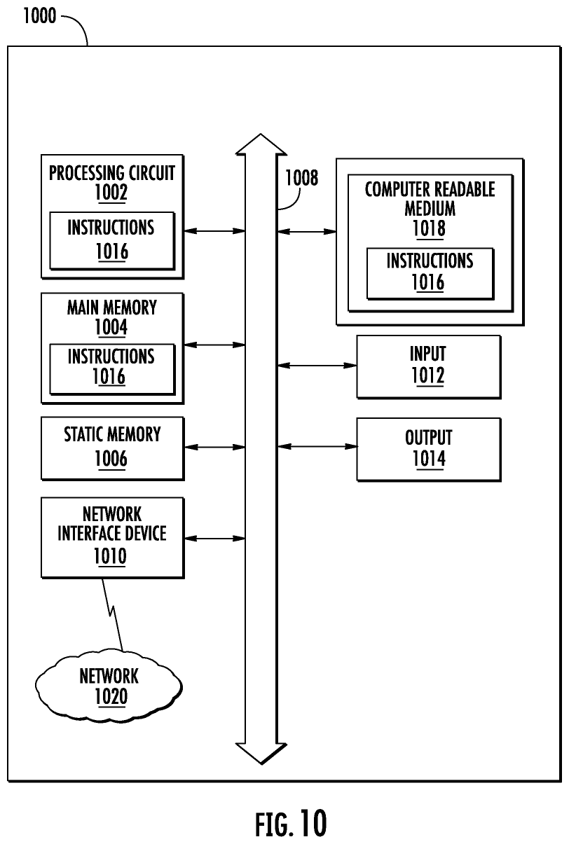

Any of the circuits, components, devices, modules described herein, including but not limited to the radio node 402 in FIGS. 4 and 6, can include or be included in a computer system 1000, such as that shown in FIG. 10, to carry out their functions and operations as described herein. With reference to FIG. 10, the computer system 1000 includes a set of instructions for causing the multi-operator radio node component(s) to provide its designed functionality, and the circuits discussed above. The multi-operator radio node component(s) may be connected (e.g., networked) to other machines in a LAN, an intranet, an extranet, or the Internet. The multi-operator radio node component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 1000 in this embodiment includes a processing circuit or processor 1002, a main memory 1004 (e.g., read-only memory (ROM), flash memory, dynamic random-access memory (DRAM) such as synchronous DRAM (SDRAM), etc.), and a static memory 1006 (e.g., flash memory, static random access memory (SRAM), etc.), which may communicate with each other via a data bus 1008. Alternatively, the processing circuit 1002 may be connected to the main memory 1004 and/or static memory 1006 directly or via some other connectivity means. The processing circuit 1002 may be a controller, and the main memory 1004 or static memory 1006 may be any type of memory.

The processing circuit 1002 represents one or more general-purpose processing circuits such as a microprocessor, central processing unit, or the like. More particularly, the processing circuit 1002 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 1002 is configured to execute processing logic in instructions 1016 for performing the operations and steps discussed herein.

The computer system 1000 may further include a network interface device 1010. The computer system 1000 also may or may not include an input 1012 to receive input and selections to be communicated to the computer system 1000 when executing instructions. The computer system 1000 also may or may not include an output 1014, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 1000 may or may not include a data storage device that includes instructions 1016 stored in a computer-readable medium 1018. The instructions 1016 may also reside, completely or at least partially, within the main memory 1004 and/or within the processing circuit 1002 during execution thereof by the computer system 1000, the main memory 1004 and the processing circuit 1002 also constituting the computer-readable medium 1018. The instructions 1016 may further be transmitted or received over a network 1020 via the network interface device 1010.

While the computer-readable medium 1018 is shown in an exemplary embodiment to be a single medium, the term “computer-readable medium” should be taken to include a single medium or multiple media (e.g., a centralized or distributed database, and/or associated caches and servers) that store the one or more sets of instructions. The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. The term “computer-readable medium” and “machine-readable medium” shall also be taken to include any medium that is capable of storing, encoding or carrying a set of instructions for execution by the processing circuit and that cause the processing circuit to perform any one or more of the methodologies of the embodiments disclosed herein. For example, a computer-readable medium or a machine-readable medium includes a machine-readable storage medium (e.g., read only memory (“ROM”), random access memory (“RAM”), magnetic disk storage medium, optical storage medium, flash memory devices, etc.), solid-state memories, optical media, magnetic media, and the like. Notwithstanding this broad definition, specifically excluded from this definition are electromagnetic carrier waves or other signals that have information encoded thereon or therein but lack tangible form.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components and/or systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented as electronic hardware, instructions stored in memory or in another computer-readable medium and executed by a processor or other processing device, or combinations of both. The various illustrative logical blocks, modules, and circuits described in connection with the embodiments disclosed herein may be implemented with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein, as examples. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

We claim:

1. A radio access network, comprising:
a radio node configured to radiate a plurality of primary radio frequency (RF) beams each steered toward a respective one of a plurality of primary beam directions to thereby cover a respective one of a plurality of primary coverage areas in a coverage cell; and
one or more reflector devices each located at a respective mounting point in the coverage cell and configured to:
receive at least one of the plurality of primary RF beams; and
redirect the at least one of the plurality of primary RF beams to thereby cause at least one secondary RF beam steered toward at least one secondary beam direction to thereby cover at least one secondary coverage area in the coverage cell.

2. The radio access network of claim 1, wherein the at least one secondary coverage area is at least partially nonoverlapping with each of the plurality of primary coverage areas.

3. The radio access network of claim 1, wherein the radio node is mounted at a higher location relative to a ground than each of the one or more reflector devices.

4. The radio access network of claim 1, wherein at least one of the one or more reflector devices is a diffraction reflector configured to cause the at least one secondary RF beam to have a wider beamwidth than the at least one of the plurality of primary RF beams received by the at least one of the one or more reflector devices.

5. The radio access network of claim 4, wherein the diffraction reflector is further configured to cause the at least one secondary RF beam to be steered toward the at least one secondary beam direction that is horizontal to a ground.

6. The radio access network of claim 4, wherein the diffraction reflector is further configured to cause the at least one secondary RF beam to be steered toward a ground.

7. The radio access network of claim 1, wherein at least one of the one or more reflector devices is a reconfigurable intelligent surface (RIS) configured to cause the at least one secondary RF beam to have an equal or narrower beamwidth compared to the at least one of the plurality of primary RF beams received by the at least one of the one or more reflector devices.

8. The radio access network of claim 7, wherein the RIS is further configured to cause the at least one secondary RF beam to be steered toward the at least one secondary beam direction that is horizontal to a ground.

9. The radio access network of claim 1, wherein at least one of the one or more reflector devices is a specular reflector configured to cause the at least one secondary RF beam to have a narrower beamwidth than the at least one of the plurality of primary RF beams received by the at least one of the one or more reflector devices.

10. The radio access network of claim 9, wherein the specular reflector is further configured to cause the at least one secondary RF beam to be steered toward a ground.

11. A method for reducing beamforming overhead in a wireless communications system (WCS), comprising:
radiating a plurality of primary radio frequency (RF) beams each steered toward a respective one of a plurality of primary beam directions to thereby cover a respective one of a plurality of primary coverage areas in a coverage cell;
deploying one or more reflector devices to each receive at least one of the plurality of primary RF beams; and
configuring each of the one or more reflector devices to redirect the at least one of the plurality of primary RF beams to cause at least one secondary RF beam steered toward at least one secondary beam direction to thereby cover at least one secondary coverage area in the coverage cell.

12. The method of claim 11, further comprising causing the at least one secondary RF beam to cover the at least one secondary coverage area that is at least partially nonoverlapping with each of the plurality of primary coverage areas.

13. The method of claim 11, further comprising mounting a radio node at a higher location relative to a ground than each of the one or more reflector devices.

14. The method of claim 11, further comprising causing the at least one secondary RF beam to have a wider beamwidth than the at least one of the plurality of primary RF beams received by the at least one of the one or more reflector devices.

15. The method of claim 14, further comprising causing the at least one secondary RF beam to be steered toward the at least one secondary beam direction that is horizontal to a ground.

16. The method of claim 14, further comprising causing the at least one secondary RF beam to be steered toward a ground.

17. The method of claim 11, further comprising causing the at least one secondary RF beam to have an equal or narrower beamwidth compared to the at least one of the plurality of primary RF beams received by the at least one of the one or more reflector devices.

18. The method of claim 17, further comprising causing the at least one secondary RF beam to be steered toward the at least one secondary beam direction that is horizontal to a ground.

19. The method of claim 11, further comprising causing the at least one secondary RF beam to have a narrower beamwidth than the at least one of the plurality of primary RF beams received by the at least one of the one or more reflector devices and steered toward a ground.

20. A wireless communications system (WCS) comprising a radio access network, the radio access network comprising:
a radio node configured to radiate a plurality of primary radio frequency (RF) beams each steered toward a respective one of a plurality of primary beam directions to thereby cover a respective one of a plurality of primary coverage areas in a coverage cell; and
one or more reflector devices each located at a respective mounting point in the coverage cell and configured to:
receive at least one of the plurality of primary RF beams; and
redirect the at least one of the plurality of primary RF beams to thereby cause at least one secondary RF beam steered toward at least one secondary beam direction to thereby cover at least one secondary coverage area in the coverage cell.
